(19) United States
(12) Patent Application Publication
(10) Pub. No.: US 2012/0102693 A1
(43) Pub. Date: May 3, 2012

(54) METHOD FOR MANUFACTURING AGGLOMERATED MATERIAL AND PROFILE AND COFFIN MANUFACTURED WITH SUCH MATERIAL

(76) Inventor: Antoine ROYAL, Mortagne (FR)

(21) Appl. No.: 12/915,676

(22) Filed: Oct. 29, 2010

(51) Int. Cl. A61G 17/007; B32B 5/02; B27N 1/02

(52) U.S. Cl. 27/3; 264/109; 428/221

(57) ABSTRACT

This invention relates to a method for manufacturing agglomerated material from retified fibers. It also relates to a coffin manufactured with such material and a profile such as a joinery profile. Said method involves a first step that consists in preparing pellets where the pellet composition is formed by extruding a mixture of retified vegetal fiber in fragmented form with a thermoplastic polymer or a mixture of thermoplastic polymers, and a second step that consists in an extrusion step from at least one pellet composition, during which the pellets are heated and mixed.

This invention relates to a method for manufacturing agglomerated material from retified fibers. It also relates to a coffin manufactured with such material and a profile such as a joinery profile.

Retified fibers have undergone a retification process that consists in a mild pyrolysis conducted under inert atmosphere as described in FR2512053. This process is suitable for vegetal fibers such as wood, wood bark, straw, hemp, flax, cotton, coco, jute, ramie, kenaf, abaca, nettles, bamboo, esparto, kapok, milkweed, papaya, agave (sisal) and coir.

As an example, retified wood is treated at a temperature between 200 and 280° C., so that the hemicellulose in the wood is transformed and the lignin is cross-linked, without modifying the cellulose. The retification process improves the dimensional stability, hygroscopy and resistance to decay of the treated fiber. Moreover it does not use any external chemical and is therefore an interesting way to treat fibers with low environmental impact. Therefore, retified fibers are widely used for building house material. In fact, retified fibers and especially retified wood, serve as siding elements, section material, strip of parquet flooring or strip of terrace. Retified fibers are particularly suitable for use inside or outside a house.

Conventionally, a method is known for manufacturing objects from thermoplastic material using extrusion, in which the thermoplastic material is introduced in an extruder with a worm, heated and put under pressure. After that, it is pushed through a die in order to obtain a continuous profile. In an injection process, the material under pressure is injected into a mold, the hollow part of which has the shape of the piece to be made.

Document FR2609927 addresses the making of agglomerated material by mixing a charge of heat-treated wood and a polymer or resin. To that end, it uses a reactor with a worm in which ligneous material such as wood is introduced, heated, then transferred to a zone where it is mixed with resin and finally extruded or injected in the same way as described above. Controlling such equipment is very delicate, since once the material is introduced, only the temperature in the reactor and the worm rotation speed can be controlled. The time of holding for thermal treatment, subsequent crushing and the extrusion speed cannot be made to vary independently.

In addition, heat-treated wood that is then crushed may take the form of powder, at least in part. The introduction of such material in an extrusion or injection machine does not make it possible to precisely control the quantity of charge introduced in an extruder. Also, the introduction of the material in an extruder tends to generate clouds of dust, and particular precautions are required for overcoming such drawbacks, such as vacuum systems.

Document U.S. Pat. No. 6,280,667 also describes a joinery profile made from material comprising thermoplastic material with a plant fiber charge. The charge may for instance be wood fiber in the form of sawdust. The profile comprises an external skin obtained by co-extrusion in order to control the outer appearance and durability of the profile. The co-extrusion method makes the manufacturing process more complicated.

This invention is aimed at providing a method for manufacturing agglomerated material with a charge of retified fiber that may be easily implemented by independently controlling the manufacturing parameters and by limiting the drawbacks of implementation. It is also aimed at providing objects made of the material.

With these objectives in mind, the invention is aimed at providing a method for manufacturing agglomerated material comprising synthetic thermoplastic material. The method comprises an extrusion step from at least one pellet composition, during which the pellets are heated and mixed; it is characterized by the inclusion, prior to the extrusion step, of a pellet preparation step in which the pellet composition is formed by extruding a mixture of retified wood in fragmented form with a binder. In one embodiment the present invention provides a method for manufacturing agglomerated material comprising thermoplastic synthetic material in two steps wherein:
the first step consists in preparing pellets where the pellet composition (5) is formed by extruding a mixture of retified fibre (3) in fragmented form with a thermoplastic polymer (4) or a mixture of thermoplastic polymers (4), and
the second step consists in an extrusion step from at least one pellet composition (5), during which the pellets are heated and mixed.

The method according to the invention can involve the use of retified vegetal fiber selected among wood fiber, hemp fiber, flax fiber, cotton fiber, coco fiber, jute fiber, ramie fiber, kenaf fiber, abaca fiber, nettles fiber, bamboo fiber, esparto fiber, kapok fiber, milkweed fiber, papaya fiber, agave fiber (sisal) and coir fiber. In a preferred embodiment, the present invention relates to the above-described method where the retified fiber is wood. Thus, according to the method of the invention, the agglomerated material is not made in a single step, but in independent steps, making it possible to control the manufacturing parameters at every stage. Moreover, the preparation step may be carried out with equipment that is fitted out to address the drawbacks of the use of retified wood in fragmented form. The main drawback of agglomerated material according to the prior art is its apparent density. In fact, the density of such agglomerated material makes it difficult to further work with usual plastics manufacturing material (as examples: formation of arches during alimentation step, thermal screening, etc.). The method according to the invention provides a dense pellet composition or dense pellets, easily incorporable in the next step of the process according to the invention. Such pellets are suitable for usual plastics manufacturing material with no formation of arches during the alimentation step and no thermal screening. Particularly, in the extrusion step, complementary thermoplastic material is added. The complementary thermoplastic material is added in proportions that are selected on the basis of the final properties to be obtained. The binder may for example be selected from the following materials: polyethylene, polypropylene, paraffin or polyethylene wax. The pellet composition may then be mixed with the same material as the binder, and also other types of material that are compatible with the binder. Thus, when the binder is polyethylene, virtually any complementary thermoplastic material may be used subsequently. Paraffin is preferably solid at ambient temperature. In addition, these materials for the binder may be incinerated without emitting toxic products. The extraction of heat at the end of the life of the objects manufactured with the material does not pose any particular environmental problems.

Preferably, the pellets from the preparation step contain up to 90% of retified fiber by weight. By making the pellet composition with a high charge rate, an object can then be made with any retified fiber charge by adding complementary thermoplastic material to the pellet composition. Such addition of complementary thermoplastic material reduces the retified fiber charge in the final composition. By starting with a composition with a very high charge, the final rate can be selected from a wide range. However, it has been found that a minimum rate of binder is required to obtain a consistent pellet composition of about 10%.

According to a particular characteristic, the extrusion step includes the forming of a profile through a die.

According to another particular characteristic, the extrusion step comprises the forming of a second pellet composition.

The second pellet composition may be used for example in an additional rotary molding step. In such a process, a mould has a cavity in which the second pellet composition is introduced. The walls of the cavity are heated and the pellets are shaken in the cavity, so that all the walls are reached by pellets. These melt and agglomerate on the walls so as to form a shell. After the mould cools and is opened, a shell with a hollow interior is obtained.

Preferably, the second pellet composition is micronized before rotary molding. Micronizing consists in crushing the composition to make particles smaller than 0.5 mm. The distribution of the material in the mould and the agglomeration of particles with each other are thus improved. The invention also relates to a coffin in synthetic material, the synthetic material being agglomerated heat-treated material and polyolefin. Such material is water-repellent, which is of interest in such an application. Furthermore, in the event of incineration, the combustion of the synthetic material does not emit pollutants. Furthermore, such combustion, because of the nature of the charge, provides a large part of the energy useful for cremation. If the coffin is to be buried, the synthetic material can be biodegradable. In a particular manner, the coffin is made using the rotary-molding method as described above, where the coffin is made up of a box and a lid, obtained by dividing a hollow shell obtained by rotary molding into two.

For example, the polyolefin may be obtained from biomass. In that case, the carbon footprint of the coffin is very reduced, with very low carbon dioxide emissions. It was also observed, surprisingly, that the coating of fibers is better with polyolefin from biomass as compared with synthetic polyolefin made from petroleum. Such polyolefin is for instance made from maize or ethyl alcohol derived from the fermentation and distillation of plant material.

The invention also relates to a joinery profile made of synthetic material, where the synthetic material is agglomerated material made with heat-treated fiber and synthetic thermoplastic material. For example, the profile is made using the method as described above, but not necessarily. Such a profile is more rigid than a profile made of PVC, for example. Consequently, there is no need for reinforcement. At the end of the profile's life, recycling is easier as it does not include any heterogeneous material. Moreover, it can be incinerated simply, with no risk for the environment.

The polyolefin may for instance be derived from biomass.

The invention will be easier to understand and other particularities and benefits will appear in the description below, by reference to the drawings attached where:

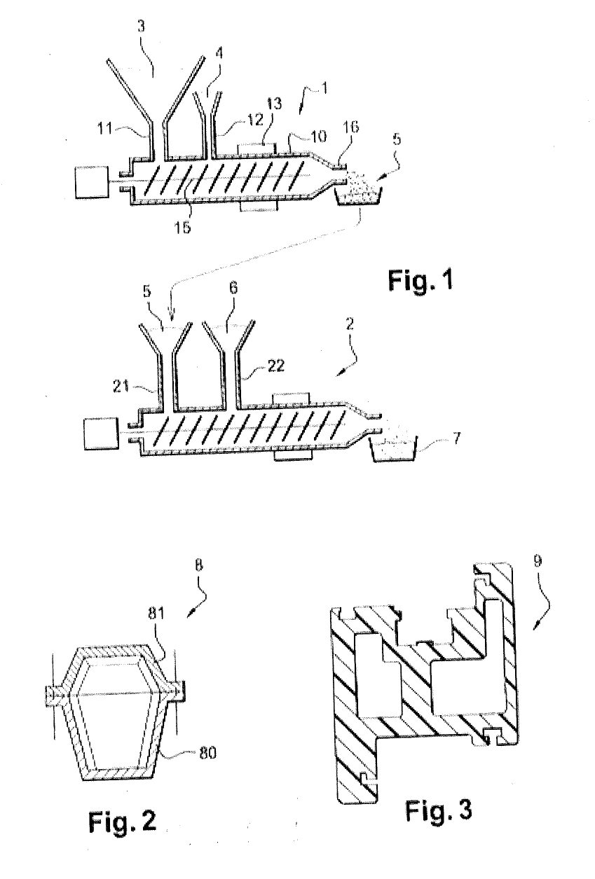

FIG. 1 is a schematic view of a method according to the invention;

FIG. 2 is a perspective view of a coffin according to the invention;

FIG. 3 is a sectional view of a joinery profile according to the invention.

The method according to the invention may also be implemented with the help of two extruders, as represented in FIG. 1. The first extruder (1) classically comprises a tubular body (10), a worm (15) assembled to rotate in body (10), a first inlet (11) to introduce a first material (3) in the body and an outlet (16) at the end opposite inlet (11) to extract the mixed material, heated and under pressure. The extruder (1) further comprises a second inlet (12) for introducing a second material (4) in order to mix it with the first material. The two inlets (11), (12) have been represented offset in order to make the drawing clearer, but they may be on the same level as the body. The mixture may also be made before the inlet. The body (10) comprises heating means (13) in order to melt the material as it passes through the extruder.

The second extruder (2) is designed in the same way as the first one.

During a preparation step, the first inlet (11) of the first extruder (1) receives retified wood (3) in fragmented form. Retified wood pieces may measure up to 1-2 cm, but may also be in the form of powder, with a mixture of pieces of intermediate sizes. The retified wood (3) is obtained for example by heating sawdust in a neutral atmosphere. It may also be obtained by crushing pieces of heat-treated wood of larger sizes, for example a few centimeters long. The second inlet (12) receives a thermoplastic polymer (4) or a mixture of thermoplastic polymers (4). The thermoplastic polymer (4) is for example polyethylene in the form of pellets measuring 2 to 15 mm. It may also be paraffin, also in the form of pellets.

The two materials (3), (4) are heated and mixed by the worm (15) in the first extruder (1). The temperature reached is approximately 160 to 190° C. The large pieces of retified wood are crushed. The composition (5) obtained in this way is extruded at the outlet into a die in order to form filaments that are regularly cut by a cutter to form pellets. The pellet composition (5) obtained in this way would have a retified wood charge of up to 90%.

The pellet composition (5) is introduced, in the extrusion step, in the second extruder (2) through the first inlet (21). A second inlet (22) receives thermoplastic material (6) such as polyolefin (polyethylene or polypropylene). A compatibility agent may possibly be added to one of the materials. Such an agent is for example known under the name Priex GP 12 from Solvay Plastics. The two materials are mixed in the extruder in order to form the agglomerated material (7), then the agglomerated material is either formed into pellets as in the preparation step shown in FIG. 1, or injected into a mould to form a molded piece.

Samples have been made by means of injection. The injection settings were as follows: the press setting temperature was 165 to 205° C., the injection pressure was 100 bar, the holding pressure was 70 bar and the cooling time was 20 seconds. The mould was not regulated. The specimens were stoved for one hour at 80° C. Tensile strength tests produced the following results:

| Formulation | Yield strength (MPa) | E modulus (MPa) |
|---|---|---|
| Polypropylene + 20% | 20.2 | 1266 |
| retified wood | | |
| Polypropylene + 40% | 24.8 | 1991 |
| retified wood | | |
| Polypropylene + 60% | 30.4 | 2922 |
| retified wood | | |

FIG. 2 shows an example of a piece made with such a pellet material (7). That piece is a coffin designed for cremation. The pellets obtained from the extrusion step are introduced in a rotary molding mould as described above. A shell with the shape of the closed coffin (8) is formed. After the shell solidifies, the shell is cut to separate it into a box (80) and a lid (81). In this mode of embodiment, the material is preferably made from polyethylene. The cover can be held closed by screws, symbolized by combined lines, made by injecting the same material.

FIG. 3 shows an example of a joinery profile (9) made by extrusion at the outlet of the second extruder. It may be made directly at the outlet of the first extruder. Such a profile (9) is designed to make the frame of a window leaf. In relation to wood-based material, it has the benefit of being water-repellent, which makes it particularly suitable to use in exterior doors and windows. The other benefit is that energy can be extracted from it at the end of its life. In addition, by using a thermoplastic made from polyolefin, the discharge of toxic gas from PVC windows and doors during a fire can be avoided.

Experiments have also been conducted using retified material made from straw, wood bark or hemp chaff. The results have been as satisfactory as with retified wood. The use of other plant materials may also be envisaged, including walnut or peanut shells, hemp or flax fibers, etc.

The invention is not limited to the mode of embodiment, which has only be described as an example. Retified wood may be replaced by any other plant fiber that has undergone the same retification treatment.

1. A method for manufacturing agglomerated material comprising thermoplastic synthetic material in two steps wherein:
the first step consists in preparing pellets where the pellet composition is formed by extruding a mixture of retified vegetal fiber in fragmented form with a thermoplastic polymer or a mixture of thermoplastic polymers, and
the second step consists in an extrusion step from at least one pellet composition, during which the pellets are heated and mixed.

2. A method according to claim 1, where the retified fiber is selected from wood fiber, hemp fiber, flax fiber, cotton fiber, coco fiber, jute fiber, ramie fiber, kenaf fiber, abaca fiber, nettles fiber, bamboo fiber, esparto fiber, kapok fiber, milkweed fiber, papaya fiber, agave fiber (sisal) and coir fiber.

3. A method according to claim 1, where the retified fiber is wood.

4. A method according to claim 1, in which complementary thermoplastic material is added in the extrusion step.

5. A method according to claim 1, in which the thermoplastic polymer is selected from the following materials: polyethylene, polypropylene, paraffin.

6. A method according to claim 1, in which the pellet composition from the preparation step contains up to 90% of retified fiber by weight.

7. A method according to claim 1, in which the extrusion step comprises the formation of a profile through a die.

8. A method according to claim 1, in which the extrusion step comprises the formation of a second pellet composition.

9. A method according to claim 8, wherein it comprises an additional rotary molding step using the second pellet composition.

10. A method according to claim 9, in which the second pellet composition is micronized before rotary molding.

11. A joinery profile made of synthetic material, wherein the synthetic material is agglomerated retified fiber and synthetic thermoplastic material.

12. A joinery profile according to claim 5, wherein the polyolefin is derived from biomass.

13. A joinery profile according to claim 5, where the retified fiber is retified wood.

14. A coffin made of synthetic material, wherein the synthetic material is agglomerated retified fibers and a polyolefin.

15. A coffin according to claim 1, wherein it is obtained by rotary molding, the coffin comprising a box and a lid obtained by dividing a hollow body obtained by the rotary molding process into two.

16. A coffin according to claim 1, wherein the polyolefin is made from the biomass.

17. A coffin according to claim 1, where the retified fiber is retified wood.
